(19) United States
(12) Patent Application Publication
(10) Pub. No.: US 2026/0356177 A1
(43) Pub. Date: Nov. 12, 2026

(54) VEHICLE WINDSHIELD HAVING A WINDSHIELD BODY ARRANGEMENT AND A CONNECTION ARRANGEMENT FOR AN ELECTRIC FUNCTIONAL APPARATUS

(71) Applicant: Webasto SE, Stockdorf (DE)

(72) Inventors: Milan MATOK, Stockdorf (DE); Michael ADAM, Stockdorf (DE); Mateusz SOJKA, Stockdorf (DE); Johann SCHUSTER, Stockdorf (DE)

(21) Appl. No.: 19/100,350

(22) PCT Filed: Jul. 13, 2023
(86) PCT No.: PCT/EP2023/069484

§ 371 Date: Jan. 31, 2025

(30) Foreign Application Priority Data
Aug. 8, 2022 (DE) 10 2022 119 912.6

(51) Int. Cl. B60J 10/70; B60J 3/04; B62D 25/06

(52) U.S. Cl. CPC B60J 10/70; B60J 3/04; B62D 25/06

(57) ABSTRACT

A vehicle windshield having a windshield body arrangement, an edge overmolding of the windshield body arrangement, an electric functional apparatus and a connection arrangement for the electric functional apparatus. The connection arrangement has a plug connector having electric contact elements and a plastic edge overmolding of the electric contact elements and which is an insert of the edge overmolding.

### CROSS-REFERENCE TO RELATED APPLICATIONS

This application is a U.S. national phase application filed under 35 U.S.C. § 371 of International Application No. PCT/EP2023/069484, filed on Jul. 13, 2023, published under WO 2024/033008 A1 on Feb. 15, 2024, designating the United States, which claims priority from German Patent Application Number 10 2022 119 912.6, filed on Aug. 8, 2022, which are hereby incorporated herein by reference in their entirety.

### FIELD

The invention relates to a vehicle windshield having the features of the preamble of claim 1.

### BACKGROUND

A vehicle windshield of this type is known in practice and is designed, for example, as a roof element which is adjustable or fixed in relation to a vehicle body. The vehicle windshield has a windshield body arrangement which comprises a windshield inner body and a windshield outer body when designed as a composite windshield. The windshield outer body forms an outer viewing surface of the vehicle windshield, and the windshield inner body forms a viewing surface of the windshield body facing the vehicle interior. A liquid crystal arrangement can be disposed between the windshield outer body and the windshield inner body and can be switched between a blocking state, in which the liquid crystal arrangement acts in the manner of a diffuser, and a transmission state, in which light can enter the vehicle interior through the vehicle windshield essentially unscattered, in order to control the entry of light into the vehicle interior through the vehicle windshield. The liquid crystal arrangement, which can be designed in particular as a so-called PDLC arrangement (polymer dispersed liquid crystal), is connected to an electric control via a cable, such as a ribbon cable. The ribbon cable is routed from the space between the windshield outer body and the windshield inner body to the underside of the vehicle windshield, where it is connected to a wiring harness leading to the control via soldered or welded joints. The connection point between the wiring harness and the ribbon cable is accommodated by an edge overmolding of the vehicle windshield, which forms a plastic frame and can in particular be made of a polyurethane foam layer. This means that the connection points are electrically insulated and mechanically protected. However, the connection of the ribbon cable to the wiring harness and the edge overmolding of the connection points with the polyurethane foam material involves many production steps. Furthermore, the wiring harness must already be connected to the ribbon cable when molding the edge overmolding to the windshield body arrangement. This entails the risk of the wiring harness being damaged during the production process. The wiring harness must also always be protected from damage during subsequent transportation of the vehicle windshield.

### SUMMARY

The object of the invention is therefore to produce a vehicle windshield which is designed according to the type mentioned above and allows a reliable electric connection of an electric functional apparatus and an simpler future connection to a wiring harness leading to an electric control.

According to the invention, this object is attained by the vehicle windshield having the features of claim 1.

According to the invention, a vehicle windshield is thus proposed which comprises a windshield body arrangement, an edge overmolding of the windshield body arrangement, an electric functional apparatus and a connection arrangement for the electric functional apparatus. The connection arrangement in turn comprises electric contact elements which are overmolded by a plastic component which forms a plug connector which is an insert of the edge overmolding.

In the vehicle windshield according to the invention, a plug connector is thus incorporated in the edge overmolding, to which a plug-connector counterpart of a connection cable, in particular a wiring harness, can be connected in a simple manner, which leads to an electric control for the electric functional apparatus. This means it is not necessary for the connection cable or wiring harness to be connected to the electric functional apparatus and/or to be a component of the connection arrangement for the electric functional apparatus when the vehicle windshield is being manufactured. Instead, the connection cable and/or wiring harness can be connected to the electric functional apparatus via the plug connector directly during assembly of the vehicle in question, after the vehicle windshield has been manufactured and transported.

The number of electric contact elements of the connection arrangement, which are overmolded by the first plastic component, depends on the number of conductors of the cable, which is connected to the electric functional apparatus. The electric contact elements can be welded, soldered or crimped to the conductors of this cable. After the electric contact elements have been connected, the electric contact elements are foam-layered with the first plastic component in a corresponding injection mold. This means the connection point between the electric contact elements and the cable leading to the electric functional apparatus is protected and insulated by the first plastic component. In this injection molding process, the geometry of a plug connector is formed, which can be connected to a plug-connector counterpart of a connection cable or the like, which leads to an electric control for the electric functional apparatus. Subsequently, the edge overmolding is formed in a further mold, the plastic component and/or the plug connector being firmly connected to the windshield body arrangement by the edge overmolding so that the plug connector is positioned in particular on the underside of the windshield body arrangement. The edge overmolding is, for example, an edge overmolding made of a polyurethane foam material. The contact surfaces of the contact elements, which are part of the plug connector formed by means of the first plastic component, remain accessible from the outside. The result is a finished vehicle windshield having an integrated plug connection, namely without a connection cable. The latter can be connected via the plug connector at a given time during assembly of the vehicle windshield. Damage to the connection cable during production of the vehicle windshield or during transportation is therefore essentially precluded.

In a preferred embodiment, the plug connector has a base surface which is plane-parallel to a large surface of the windshield body arrangement and can also abut against the windshield body arrangement so that plug connector can be connected to the windshield body arrangement in a defined manner when forming the edge overmolding.

In a preferred embodiment of the vehicle windshield according to the invention, the plug connector has a tiered circumferential surface. This then also serves as an anchor surface which holds the plug connector securely in the edge overmolding. This makes it possible for the edge overmolding to at least partially overlap the plug connector and for the plug connector to be held captive by the edge overmolding.

In order to provide a harmonious appearance, in an advantageous embodiment of the vehicle windshield according to the invention, the plug connector has a front face which is disposed so as to essentially be flush with an adjacent surface of the edge overmolding.

To ensure a secure connection of a plug-connector counterpart of a connection cable, it is advantageous if the plug connector, which is formed by the plastic component, has a locking geometry which is engaged with a counter locking geometry of a plug-connector counterpart.

In order to be able to incorporate the connection arrangement of the vehicle windshield according to the invention particularly harmoniously into the edge overmolding, it preferably has a ribbon cable which is connected to the electric functional apparatus and whose electric conductors are each connected to one of the contact elements.

In order to keep the handling of the electric contact elements as simple as possible when manufacturing the plug connector, the electric contact elements together preferably form a contact rail which is overmolded by the plastic edge overmolding.

The electric functional apparatus comprises, for example, a liquid crystal arrangement which forms a switchable shading arrangement of the vehicle windshield. The liquid crystal arrangement can be a PDLC (Polymer Dispersed Liquid Crystal) arrangement, which consequently comprises a polymer matrix in which liquid crystal droplets are embedded in dispersed form. The thus formed liquid crystal layer is provided on both sides with a film made of PET (polyethylene terephthalate), PC (polycarbonate) or the like, which carries an electrode layer on its side facing the liquid crystal layer. The electrode layer can be segmented so that a segmented liquid crystal arrangement is available. The individual segments can each be connected to a conductor of the cable, each conductor being assigned to one of the contact elements of the plug connector.

In an alternative embodiment of the vehicle windshield according to the invention, the electric functional apparatus has a windshield heater. In particular, the windshield heater can be a windshield heater of a rear window, for example a rear window of a convertible top.

Furthermore, the electric functional apparatus can be a solar cell arrangement or also a lighting device, which is designed in particular as a so-called ambient light lighting device.

Further advantages and advantageous embodiments of the subject matter of the invention can be derived from the description, the drawing and the claims.

### BRIEF DESCRIPTIONS OF THE DRAWINGS

Exemplary embodiments of a vehicle windshield according to the invention are shown in the drawing in a schematically simplified manner and are described in more detail in the following description.

FIG. 1 shows a top view of a vehicle roof having a vehicle windshield according to the invention.

FIG. 2 shows a cut through an edge area of the vehicle windshield along line II-II in FIG. 1.

FIG. 3 shows a perspective view from below of an edge section of the vehicle windshield together with a wiring harness.

FIG. 4 shows a view according to FIG. 3, though without a wiring harness.

FIG. 5 shows a PDLC film together with a ribbon cable and a contact rail.

FIG. 6 shows a view according to FIG. 5, though after a plastic component has been formed on the contact rail so as to form a plug connector.

FIG. 7 shows the arrangement of the plug connector and the PDLC film on a windshield body arrangement before an edge overmolding is formed.

FIG. 8 shows a cut according to FIG. 2 through an alternative embodiment of a vehicle windshield according to the invention.

FIG. 9 shows a cut according to FIG. 2 through another embodiment of a vehicle windshield according to the invention.

### DETAILED DESCRIPTION

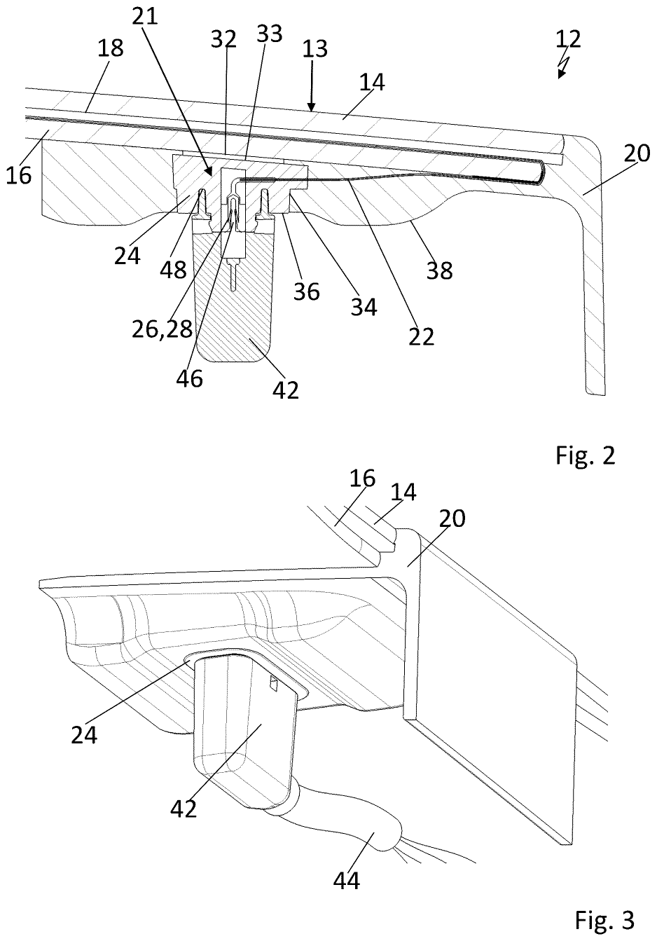

The drawing shows a vehicle roof 10 of a motor vehicle (not shown). The vehicle roof 10 is a panoramic roof which has a fixed-roof element 12, which is rigidly, i.e., immovably, connected to the vehicle body. The fixed-roof element 12 forms a vehicle windshield and comprises a composite structure, which is shown in more detail in FIG. 2. The composite structure of the fixed-roof element 12 comprises a windshield body arrangement 13 having a windshield outer body 14 and a windshield inner body 16, each of which is made of a soda-lime clear glass. The windshield outer body 14 faces the vehicle environment and forms an outer viewing surface of the respective vehicle windshield, whereas the windshield inner body 16 faces the vehicle interior and forms an inner viewing surface of the respective vehicle windshield. If necessary, the windshield outer body 14 and the windshield inner body 16 can also be made of tinted glass.

Between the windshield outer body 14 and the windshield inner body 16 is a PDLC arrangement 18, which is an electric functional apparatus and a shading arrangement of the vehicle windshield at hand. The PDLC arrangement 18 comprises a PDLC layer (layer of polymer-dispersed liquid crystals), which forms the actual shading element and comprises a solid polymer matrix in which liquid crystals are incorporated in droplet form. The PDLC layer is bordered on both sides by a plastic film which is made of a material such as PET, PC or the like and has an electrode layer on its surface facing the PDLC layer, the electrode layer being able to be made of ITO (indium tin oxide). By means of the electrode layers, a voltage can be applied to the PDLC layer so that the transmission behavior of the PDLC layer can be changed. This makes it possible to adjust the PDLC layer and/or the PDLC arrangement 18 between a blocking state, in which the PDLC layer is essentially opaque, and a transmission state, in which direct light can enter the vehicle interior through the vehicle windshield.

Furthermore, the fixed-roof element 12 is provided with a frame-like edge overmolding 20, in particular made of a polyurethane foam material, which covers the edges of the windshield outer body 14 and the windshield inner body 16 and a lower edge surface of the windshield inner body 16.

A connection arrangement 21 is provided for the electric connection of the, in particular, segmented electrode layers of the PLDC arrangement 18 and comprises a ribbon cable 22 whose conductors 30 are each electrically connected to a segment of the electrode layers. The ribbon cable 22 surrounds an edge of the windshield inner body 16 and, embedded in the edge overmolding 20, leads to a plug connector 24, which is accommodated as an insert in the edge overmolding 20 and is also a component of the integrated connection arrangement 21.

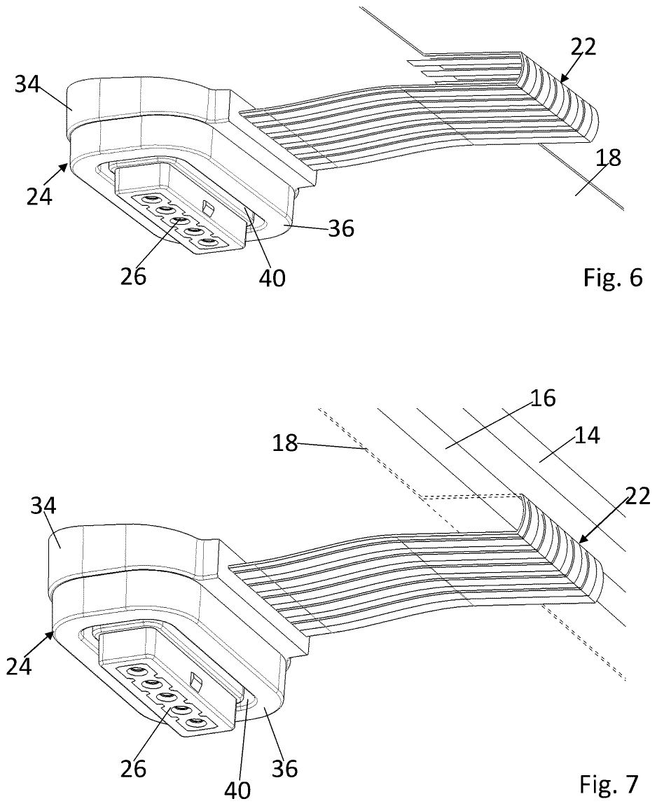

The plug connector 24 comprises a contact rail 26, shown in particular in FIG. 5, which has a plurality of contact elements 28, each of which is connected to one of the conductors 30 of the ribbon cable 22. The contact rail 26 is surrounded and/or overmolded by a plug casing 32, which is formed from a plastic material and into which, as can be seen in FIGS. 6 and 7, the ribbon cable 22 opens with its end facing away from the PDLC arrangement 18.

The plug casing 32 of the plug connector 24, which thus forms a plastic edge overmolding of the contact rail 26, has a base surface 33, which is plane-parallel to the underside of the windshield inner body 16, and a tiered circumferential surface 34, which is accommodated by the plastic edge overmolding and forms an anchor surface for the plug connector 24 in the edge overmolding 20. A front face 36 of the plug connector 24 and/or the plug casing 32 merges flush with a lower viewing surface 38 of the edge overmolding 20.

The plug casing 32 of the plug connector 24 has an undercut groove 40 surrounding the contact rail 26 to form a latching geometry. Furthermore, the latching geometry may comprise lugs, apertures and/or the like.

The plug connector 24 accommodated in the edge overmolding 20 as a so-called insert can be coupled to a plug-connector counterpart 42, which is part of a wiring harness 44 forming a connection cable, which leads to an electric control (not shown in detail) for the PDLC arrangement 18. On its contact side, the plug-connector counterpart 42 has contact pins 46, the contact pins 46 engaging in the contact elements 28 of the contact rail 26 of the plug connector 24, and a counter locking geometry 48, which is designed to correspond to the groove 40, so that the plug-connector counterpart 42 can be securely locked to the plug connector 24.

The connection arrangement 21 is integrated into the windshield structure during the production of the fixed-roof element 12 as follows.

In a first step, the ribbon cable 22, which is connected to at least one of the electrode layers of the PDLC arrangement 18, is connected to the contact elements 28 of the contact rail 26 at its end facing away from the PDLC arrangement 18 via a soldering, welding or crimping process, this being done in such a manner that the axes of the contact elements 28 have an orientation of approximately 90° relative to the corresponding conductors 30 of the ribbon cable 22 (see FIG. 5).

In a further manufacturing step, the contact rail 26 and the connection points between the ribbon cable 22 and the contact rail 26 are overmolded with plastic in a corresponding injection molding process to form the plug housing 32, the geometry described above being formed with the base surface 33, the circumferential surface 34, the front face 36 and the latching geometry (see FIG. 6).

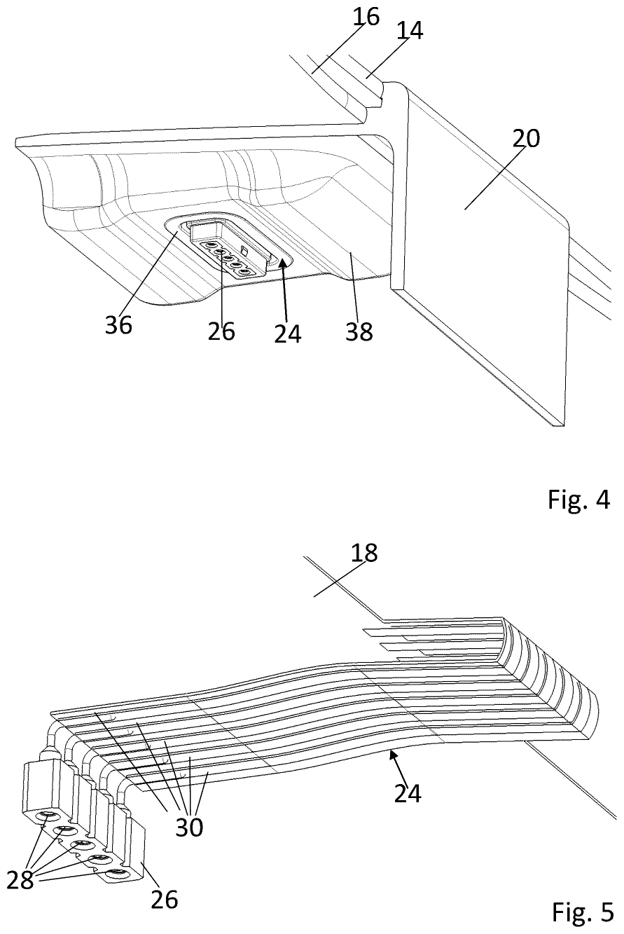

The PDLC arrangement 18 with the thus formed connection arrangement 21, which comprises the ribbon cable 22 and the plug connector 24, is then integrated into the composite structure, which comprises the windshield outer body 14 and the windshield inner body 16 (see FIG. 7). The composite structure is then inserted into a corresponding foaming tool to form the edge overmolding 20. The plug connector 24 is held in such a manner that the base surface 33 is plane-parallel to the underside of the windshield inner body 16, which forms a large surface, or abuts against it. The polyurethane foam material is then introduced into the cavity of the foaming tool so that the edge overmolding 20 is formed. The plug connector 24 is thus integrated into the edge overmolding 20 as an insert (see FIG. 4). The contact elements 28 of the contact rail 26 remain free so that the plug-connector counterpart 42 can be electrically and mechanically connected to the plug connector 24 (see FIGS. 2 and 3).

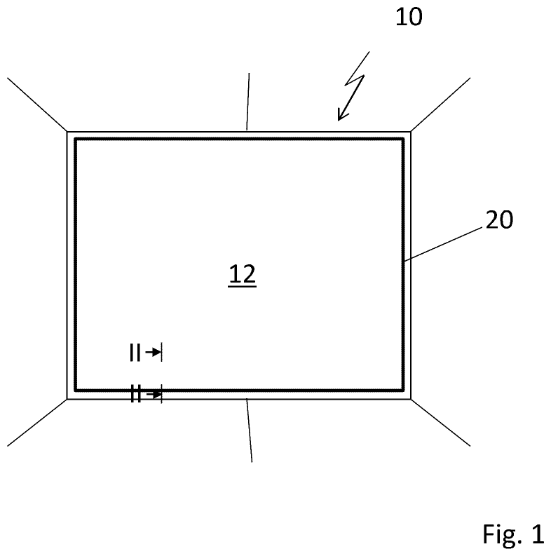

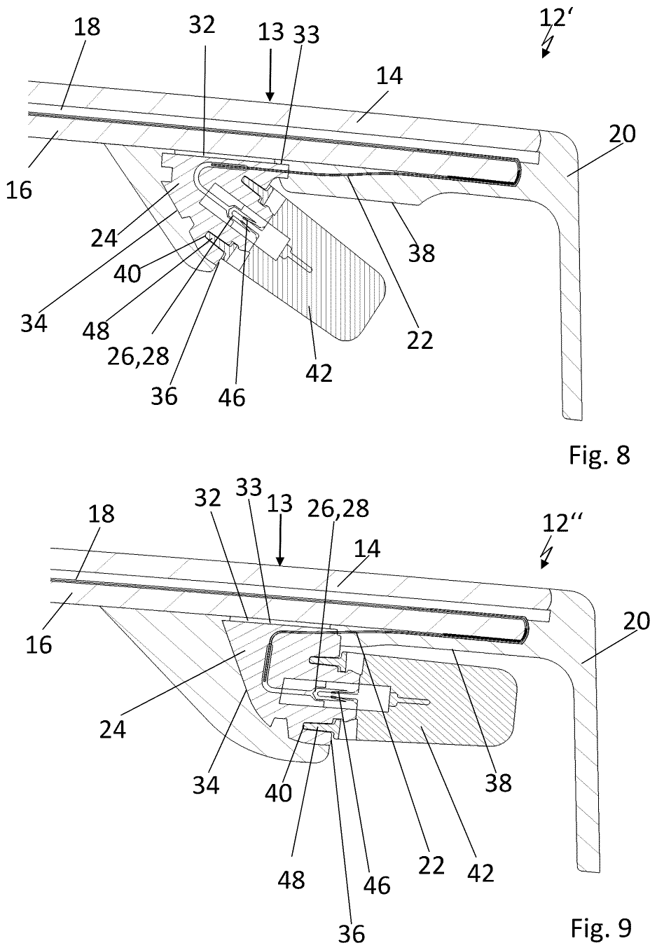

FIG. 8 shows a vehicle windshield 12′ which largely corresponds to that shown in FIGS. 1 to 7 and also forms a fixed-roof element. The vehicle windshield 12′ differs from the vehicle windshield described above in that the plug connector 24, which is accommodated by the edge overmolding 20, is shaped in such a manner that the plug-connector counterpart 42 can be plugged on from diagonally below in relation to the plane of the windshield body arrangement 13; i.e., a longitudinal central plane of the plug-connector counterpart 42 forms an angle of approximately 40° with the plane of the windshield body arrangement 13. The cable routing in the plug casing 32 is adapted to this angle. The front face 36 of the plug connector 24 is also inclined relative to the plane of the windshield body arrangement 13. In all other respects, the vehicle windshield 12′ corresponds to that shown in FIGS. 1 to 7, for which reason reference is made to the relevant description in order to avoid repetition.

FIG. 9 shows a vehicle windshield 12″ which largely corresponds to that shown in FIG. 8, but differs from it in that the plug connector 24, which is accommodated by the edge overmolding 20, is shaped in such a manner that its front face 36 is disposed at least approximately at a right angle to the plane of the windshield body arrangement 13. The plug-connector counterpart 42 can therefore be plugged on parallel to the plane of the windshield body arrangement 13; i.e., the longitudinal center plane of the plug-connector counterpart 42 is at least approximately parallel to this plane. In all other respects, the vehicle windshield 12″ corresponds to that shown in FIG. 8, for which reason reference is made to the relevant description.

The orientation of the plug connector 24 in the edge overmolding 20 and its geometry can therefore vary over a wide range.

### LIST OF REFERENCE NUMERALS

10 vehicle roof
12, 12′, fixed-roof element, vehicle windshield
13 windshield body arrangement
14 windshield outer body
16 windshield inner body
18 PDLC arrangement
20 edge overmolding
21 connection arrangement
22 ribbon cable
24 plug connector
26 contact rail
28 contact elements
30 conductor
32 plug casing
33 base surface
34 circumferential surface
36 front face
38 viewing surface
40 groove
42 plug-connector counterpart
44 wiring harness
46 contact pin
48 counter locking geometry

1. A vehicle windshield, comprising:
a windshield body arrangement,
an edge overmolding of the windshield body arrangement,
an electric functional apparatus and a connection arrangement for the electric functional apparatus,
wherein the connection arrangement comprises a plug connector which comprises electric contact elements and a plastic edge overmolding of the electric contact elements and which is an insert of the edge overmolding.

2. The vehicle windshield according to claim 1, wherein the plug connector has a base surface which is plane-parallel to a large surface of the windshield body arrangement.

3. The vehicle windshield according to claim 1, wherein the plug connector has a tiered circumferential surface.

4. The vehicle windshield according to claim 1, wherein the plug connector has a front face which is disposed so as to essentially be flush with an adjacent surface of the edge overmolding.

5. The vehicle windshield according to claim 1, wherein the plug connector comprises a locking geometry which is engaged with a counter locking geometry of a plug-connector counterpart.

6. The vehicle windshield according to claim 1, wherein the connection arrangement comprises a ribbon cable which is connected to the electric functional apparatus and whose electric conductors are each connected to one of the contact elements.

7. The vehicle windshield according to claim 1, wherein the electric contact elements form a contact rail which is overmolded by the plastic edge overmolding.

8. The vehicle windshield according to claim 1, wherein the electric functional apparatus comprises a liquid crystal arrangement which forms a component of a switchable shading arrangement of the vehicle windshield.

9. The vehicle windshield according to claim 1, wherein the electric functional apparatus comprises a windshield heater.

10. The vehicle windshield according to claim 1, wherein the windshield body arrangement comprises a windshield outer body and a windshield inner body and the electric functional apparatus is disposed between the windshield outer body and the windshield inner body.

11. The vehicle windshield according to claim 1, wherein the vehicle windshield is a roof windshield of a vehicle roof.

12. The vehicle windshield according to claim 1, wherein the vehicle windshield a rear windshield of a convertible vehicle.

13. The vehicle windshield according to claim 8, wherein the liquid crystal arrangement is a PDLC arrangement.

14. The vehicle windshield according to claim 12, wherein the rear windshield is a rear windshield of a convertible vehicle.
